(19) United States
(12) Patent Application Publication
(10) Pub. No.: US 2025/0292059 A1
(43) Pub. Date: Sep. 18, 2025

(54) DATA PROCESSING METHOD AND APPARATUS, DEVICE, AND MEDIUM

(71) Applicant: Beijing Zitiao Network Technology Co., Ltd., Beijing (CN)

(72) Inventors: Songwei LIU, Beijing (CN); Mingxi LI, Beijing (CN); Fangyuan KONG, Beijing (CN); Fangmin CHEN, Beijing (CN); Yang BAI, Beijing (CN)

(21) Appl. No.: 18/859,935

(22) PCT Filed: May 12, 2023
(86) PCT No.: PCT/CN2023/093805

§ 371 Date: Oct. 24, 2024

(30) Foreign Application Priority Data
May 13, 2022 (CN) 202210524932.0

(51) Int. Cl. G06N 3/04

(52) U.S. Cl. CPC G06N 3/04

(57) ABSTRACT

Embodiments of the present disclosure relate to a data processing method and apparatus, a device, and a medium. The method comprises: respectively performing pruning processing on candidate network layers in an original neural network according to a plurality of preset pruning rates to obtain a plurality of corresponding sub-neural networks; respectively inputting test data sets into the original neural network and the plurality of sub-neural networks for processing, and obtaining, on the basis of output data sets of the original neural network and the plurality of sub-neural networks, a reference performance index corresponding to the original neural network and a plurality of test performance indexes corresponding to the plurality of sub-neural networks; and analyzing, according to performance losses of the plurality of test performance indexes relative to a reference performance index, parameter redundancies of parameters of the candidate network layers in the original neural network under different pruning rates.

The present application is based on and claims priority to Chinese Application No. 202210524932.0 filed on May 13, 2022, the disclosure of which is incorporated by reference herein in its entirety.

### TECHNICAL FIELD

The present disclosure relates to the field of computer technologies, and in particular a data processing method and apparatus, a device, and a medium.

### BACKGROUND

Artificial intelligence technologies based on neural networks are applied to mobile terminals, and the rapid development of intelligent mobile terminals meets people's various application requirements. Main implementation technologies thereof include data processing based on trained neural network model data in video processing language recognition, image recognition and understanding, game vision and other application fields. In view of the limited computing resources of the mobile terminals, considering that the vast majority of convolutional neural networks all have a certain degree of parameter redundancy, neural networks with smaller computing resources and storage resources can be obtained on the mobile terminals by pruning the redundant convolutional kernels or neurons on the convolutional kernels in each of layers of the neural networks.

### SUMMARY

In order to solve or at least partially solve the above technical problems, the present disclosure provides a data processing method and apparatus, a device, and a medium.

An embodiment of the present disclosure provides a data processing method, which comprises:
performing pruning processes on a candidate network layer in an original neural network according
to a preset plurality of pruning rates respectively, so as to acquire a corresponding plurality of sub-neural networks;
inputting a test data set into the original neural network and the plurality of sub-neural networks respectively for processing, and acquiring a reference performance index corresponding to the original neural network and a plurality of test performance indexes corresponding to the plurality of sub-neural networks based on output data sets of the original neural network and the plurality of sub-neural networks;
analyzing parameter redundancies of parameters of the candidate network layer in the original neural network at different pruning rates according to performance losses of the plurality of test performance indexes relative to the reference performance index.

In an optional implementation, the method further comprises:
acquiring a network compression requirement;
setting the plurality of pruning rates according to the network compression requirement, wherein a difference between the plurality of pruning rates is positively correlated to a network compression degree.

In an optional implementation, the performing pruning processes according to a preset plurality of pruning rates respectively so as to acquire a corresponding plurality of sub-neural networks comprises:
performing norm calculation on a weight distribution in the candidate network layer;
if it is determined according to a calculation result that the weight distribution belongs to a candidate network layer of a preset first regional distribution, then performing the pruning processes by using a preset first pruner, wherein a norm interval of the first regional distribution is greater than a preset interval threshold, and a minimum norm value of the first regional distribution is zero;
if it is determined according to the calculation result that the weight distribution belongs to a candidate network layer of a preset second regional distribution, then performing the pruning processes by using a preset second pruner, wherein a norm variance of the second regional distribution is greater than a preset variance threshold, and a minimum norm value of the second regional distribution is not zero.

In an optional implementation, the test data set includes multimedia data, wherein the multimedia data is one or more combinations of audio data, video data, and image data.

In an optional implementation, the inputting a test data set into the original neural network and the plurality of sub-neural networks respectively for processing, and acquiring a reference performance index corresponding to the original neural network and a plurality of test performance indexes corresponding to the plurality of sub-neural networks based on output data sets of the original neural network and the plurality of sub-neural networks, comprises:
inputting a test image data set into the original neural network and each of the plurality of sub-neural networks respectively for processing, and acquiring a peak signal-to-noise ratio corresponding to the original neural network as the reference performance index and a peak signal-to-noise ratio corresponding to each of the plurality of sub-neural networks as the test performance index based on a pixel processing result between image data sets output from the original neural network and the plurality of sub-neural networks and the test image data set;
or,
inputting a test audio data set into the original neural network and each of the plurality of sub-neural networks respectively for processing, and acquiring an accuracy rate corresponding to the original neural network as the reference performance index and an accuracy rate corresponding to each of the sub-neural networks as the test performance index based on a comparison result between identified text data sets output from the original neural network and the plurality of sub-neural networks and a labeled text of the test audio data set.

In an optional implementation, the method further comprises:
detecting whether there are associated network layers with channel dependency characteristic in the original neural network, wherein the channel dependency characteristic include: adjacent network layers have at least one of a data addition operation and a data multiplication operation;
if there are the associated network layer, then setting all the associated network layers with the channel dependency characteristic as one candidate network layer.

In an optional implementation, the method further comprises:
determining a target network layer pruned in the original neural network according to parameter redundancies of parameters of the candidate network layer at different pruning rates, so as to generate a target neural network to process a target data set.

In an optional implementation, the determining a target network layer pruned in the original neural network according to parameter redundancies of parameters of the candidate network layers at different pruning rates, comprises:
drawing a performance index curve corresponding to the plurality of pruning rates for the candidate network layer according to performance losses of the plurality of test performance indexes relative to the reference performance index;
calculating a slope of each of the plurality of pruning rates in the performance index curve, and determining a maximum pruning rate of the candidate network layer according to a change of the slope, wherein the performance index corresponding to the maximum pruning rate represents a maximum parameter redundancy of the parameters of the candidate network layer;
determining the target network layer pruned in the original neural network according to a target pruning rate, and the maximum pruning rate corresponding to the maximum parameter redundancy of each of the candidate network layers.

An embodiment of the present disclosure also provides a data processing apparatus, which comprises:
a pruning processing module for performing pruning processes on a candidate network layer in an original neural network according to a preset plurality of pruning rates respectively, so as to acquire a corresponding plurality of sub-neural networks;
a process acquisition module for inputting a test data set into the original neural network and the plurality of sub-neural networks respectively for processing, and acquiring a reference performance index corresponding to the original neural network and a plurality of test performance indexes corresponding to the plurality of sub-neural networks based on output data sets of the original neural network and the plurality of sub-neural networks;
a determination module for analyzing parameter redundancies of parameters of the candidate network layer in the original neural network at different pruning rates according to performance losses of the plurality of test performance indexes relative to the reference performance index.

An embodiment of the present disclosure also provides an electronic device, which comprises: a processor; a memory for storing executable instructions; wherein the executable instructions can be read from the memory and executed by the processor to implement the data processing method provided by the embodiment of the present disclosure.

An embodiment of the present disclosure also provides a computer readable storage medium storing a computer program, which is used for executing the data processing method provided by the embodiment of the present disclosure.

An embodiment of the present disclosure also provides a computer program product including computer programs/instructions which, when executed by a processor, implement the above method.

An embodiment of the present disclosure also provides a computer program, comprising: instructions which, when executed by a processor, cause the processor to execute the data processing method provided by the embodiment of the present disclosure.

### BRIEF DESCRIPTION OF THE DRAWINGS

The above and other features, advantages and aspects of embodiments of the present disclosure will become more apparent by referring to the following specific implementations when taken in conjunction with the accompanying drawings. Throughout the drawings, the same or similar reference numerals indicate the same or similar elements. It should be understood that the drawings are schematic, and the originals and elements are not necessarily drawn to scale.

FIG. 1 is a schematic flow diagram of a data processing method provided by an embodiment of the present disclosure;

FIG. 2 is a schematic flow diagram of another data processing method provided by an embodiment of the present disclosure;

FIG. 3 is a schematic diagram of a relationship between pruning rates and performance indexes provided by an embodiment of the present disclosure;

FIG. 4 is a schematic diagram of another relationship between pruning rates and performance indexes provided by an embodiment of the present disclosure;

FIG. 5 is a schematic structural diagram of a data processing apparatus provided by an embodiment of the present disclosure;

FIG. 6 is a schematic structural diagram of an electronic device provided by an embodiment of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure can be implemented in various forms and should not be construed as limited to the embodiments set forth here, but rather, these embodiments are provided for a more thorough and complete understanding of the present disclosure. It should be understood that the drawings and embodiments of the present disclosure are only used for illustrative purposes, and are not used to limit the protection scope of the present disclosure.

It should be understood that the steps described in the method implementations of the present disclosure can be performed in a different order and/or in parallel. Furthermore, method implementations can include additional steps and/or omit performing the illustrated steps. The scope of the present disclosure is not limited in this respect.

As used herein, the term “including” and its variants are open-ended including, that is, “including but not limited to”. The term “based on” is “at least partially based on”. The term “one embodiment” means “at least one embodiment”; the term “another embodiment” means “at least one other embodiment”; the term “some embodiments” means “at least some embodiments”. Related definitions of other terms will be given in the following description.

It should be noted that the concepts of “first” and “second” mentioned in the present disclosure are only used to distinguish different means, modules or units, and are not used to limit the order or interdependence of the functions performed by these means, modules or units.

It should be noted that the modifications of “one” and “a plurality of” mentioned in the present disclosure are schematic rather than limiting, and those skilled in the art should understand that unless the context clearly indicates otherwise, they should be understood as “one or a plurality of”.

Names of messages or information exchanged among a plurality of means in the implementations of the present disclosure are only used for illustrative purposes, and are not used to limit the scope of these messages or information.

In the related art, the pruning solutions make the network processing performance different after pruning, and some pruning solutions lead to poor network processing performance, so as to lead to unreliable results of subsequent data processing.

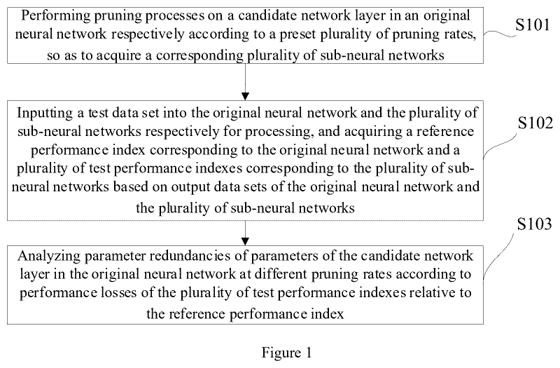

FIG. 1 is a schematic flow diagram of a data processing method provided by an embodiment of the present disclosure, which can be executed by a data processing apparatus, wherein the apparatus can be implemented by software and/or hardware, and generally can be integrated in an electronic device. As shown in FIG. 1, the method includes:

Step 101, performing pruning processes on a candidate network layer in an original neural network according to a preset plurality of pruning rates respectively, so as to acquire a corresponding plurality of sub-neural networks.

In order to ensure the model effect, there may be a certain amount of parameter redundancies in the neural network. Under the premise of ensuring the precision of the neural network, redundant convolutional kernels (that is, structured pruning) or neurons on the convolutional kernels (that is, non-structured pruning) of convolutional layers in the neural network can be pruned through the pruning processes, so that a “slimming model” occupying smaller computing resources and storage resources is obtained, the reasoning procedure of the neural network is accelerated, and the edge deployment of the neural network is facilitated.

However, different pruning solutions make the network processing performance different after pruning, and some pruning solutions lead to poor network processing performance, so as to lead to unreliable results of data processing.

In the present embodiment, the original neural network is a neural network model that needs to be pruned, and the neural network model can be obtained through training and can be set according to an application scenario and/or requirements of user, which is not limited by the present embodiment.

In the embodiment of the present disclosure, relative importance of all neurons in the original neural network are ranked by using a specific evaluation criterion, and then relatively less important neurons in the network are pruned according to a preset pruning rate, thereby compressing the network model.

In the embodiment of the present disclosure, pruning processes are performed on a candidate network layer in an original neural network according to a preset plurality of pruning rates respectively, so as to acquire a corresponding plurality of sub-neural networks; wherein the original neural network includes a plurality of candidate network layers. For example, the original neural network includes four convolutional layers, namely, convolutional layer 1 (Conv1), convolutional layer 2 (Conv2), convolutional layer 3 (Conv3) and convolutional layer 4 (Conv4), respectively, so convolutional layer 1 (Conv1), convolutional layer 2(Conv2), convolutional layer 3 (Conv3) and convolutional layer 4 (Conv4) can all be taken as candidate network layers of the original neural network, or convolutional layer 1 (Conv1) and convolutional layer 2 (Conv2) can be taken as candidate network layers. The settings can be specifically selected according to needs of an application scenario.

A corresponding pruning rate is preset according to the importance of each of the candidate network layers. The pruning rate refers to a percentage of convolutional kernels pruned from the candidate network layer. For example, candidate network layer A has N convolutional kernels and the pruning rate is p%, so N times p% convolutional kernels need to be pruned from candidate network layer A.

In the embodiment of the present disclosure, a plurality of different pruning rates are preset for each of the candidate network layers, so that after performing a pruning process on each of the candidate network layers according to the preset plurality of different pruning rates respectively, a plurality of sub-neural networks corresponding to each of the candidate network layers can be obtained. For example, ten pruning rates are preset, and each of the pruning rates differs by ten percent, namely ten percent, twenty percent, thirty percent, . . . , and one hundred percent, respectively, so that the candidate network layer, e.g. convolution layer 1 (Conv1), is processed based on the ten different pruning rates respectively, thus obtaining ten sub-neural networks corresponding to convolutional layer 1 (Conv1).

In the embodiment of the present disclosure, there are various ways to perform pruning processes according to a preset plurality of pruning rates respectively so as to acquire a corresponding plurality of sub-neural networks, which can be selected according to an application scenario, etc. and is not limited by the present embodiment. Examples are as follows:

In an optional implementation, it is possible to perform norm calculation on a weight distribution in the candidate network layer; if it is determined according to a calculation result that the weight distribution belongs to a candidate network layer of a preset first regional distribution, then the pruning processes are performed by using a preset first pruner, wherein a norm interval of the first regional distribution is greater than a preset interval threshold, and a minimum norm value of the first regional distribution is zero; if it is determined according to the calculation result that the weight distribution belongs to a candidate network layer of a preset second regional distribution, then the pruning processes are performed by using a preset second pruner, wherein a norm variance of the second regional distribution is greater than a preset variance threshold, and a minimum norm value of the second regional distribution is not zero.

In another optional implementation, related pruners are called according to a preset plurality of pruning rates to directly perform pruning processes on the candidate network layer of the original neural network, so as to obtain a plurality of sub-neural networks.

It should be noted that each time the processing is performed for one candidate network layer according to one preset pruning rate, while other candidate network layers remain unchanged, and one sub-neural network is obtained.

Step 102, inputting a test data set into the original neural network and the plurality of sub-neural networks respectively for processing, and acquiring a reference performance index corresponding to the original neural network and a plurality of test performance indexes corresponding to the plurality of sub-neural networks based on output data sets of the original neural network and the plurality of sub-neural networks.

In the embodiment of the present disclosure, the test data set can be selected and set according to the application scenario, such as multimedia data, which is one or more combinations of audio data, video data and image data.

The reference performance index refers to a performance value obtained by analyzing the output data set obtained after the original neural network processes the test data set, and the test performance index refers to a performance value obtained by analyzing the output data set obtained after the sub-neural network that has been pruned processes the test data set.

Specifically, the sub-neural networks having been pruned at different pruning rates have different precision losses in processing the test data set, that is, performance losses are different. For example, after the candidate network layer is pruned at a pruning rate of 30%, the greater the precision loss in processing the test data set by the sub-neural network, that is, the greater the performance loss, the smaller the parameter redundancy of the candidate network layer at the pruning rate of 30%.

In the embodiment of the present disclosure, different reference performance index and test performance index are obtained for the test data set in a different scenario. Therefore, there are many ways to input a test data set into the original neural network and the plurality of sub-neural networks respectively for processing, and acquire a reference performance index corresponding to the original neural network and a plurality of test performance indexes corresponding to the plurality of sub-neural networks based on output data sets of the original neural network and the plurality of sub-neural networks, which can be selected according to an application scenario, etc. and is not limited by the present embodiment. Examples are as follows.

In an optional implementation, such as a scenario with an enhanced picture quality, it is possible to input a test image data set into the original neural network and each of the plurality of sub-neural networks respectively for processing, and acquire a peak signal-to-noise ratio corresponding to the original neural network as the reference performance index and a peak signal-to-noise ratio corresponding to each of the plurality of sub-neural networks as the test performance index based on a pixel processing result between output image data sets of the original neural network and the plurality of sub-neural networks and the test image data set.

In another optional implementation, such as a speech recognition scenario, it is possible to input a test audio data set into the original neural network and each of the plurality of sub-neural networks respectively for processing, and acquire an accuracy rate corresponding to the original neural network as the reference performance index and an accuracy rate corresponding to each of the plurality of sub-neural networks as the test performance index based on a comparison result between identified text data sets output from the original neural network and the plurality of sub-neural networks and labeled text of the test audio data set.

Step 103: analyzing parameter redundancies of parameters of the candidate network layer in the original neural network at different pruning rates according to performance losses of the plurality of test performance indexes relative to the reference performance index.

In the embodiment of the present disclosure, for each of the candidate network layers, the number of different pruning rates corresponds to the number of sub-neural networks, and the number of sub-neural networks corresponds to the number of test performance indexes. Therefore, by calculating performance losses of the plurality of test performance indexes relative to the reference performance index, it is possible to obtain the parameter redundancies of parameters of the candidate network layer in the original neural network at different pruning rates.

Specifically, according to performance losses of the plurality of test performance indexes relative to the reference performance index, a performance index curve of the candidate network layer corresponding to the plurality of pruning rates is drawn, and the parameter redundancies of parameters of the candidate network layer at different pruning rates are analyzed based on the performance index curve.

The data processing solution provided by the embodiment of the present disclosure comprises performing pruning processes on a candidate network layer in an original neural network according to a preset plurality of pruning rates respectively, so as to acquire a corresponding plurality of sub-neural networks; inputting a test data set into the original neural network and the plurality of sub-neural networks respectively for processing, and acquiring a reference performance index corresponding to the original neural network and a plurality of test performance indexes corresponding to the plurality of sub-neural networks based on output data sets of the original neural network and the plurality of sub-neural networks; analyzing parameter redundancies of parameters of the candidate network layer in the original neural network at different pruning rates according to performance losses of the plurality of test performance indexes relative to the reference performance index. By adopting the above technical solution, the parameter redundancies are acquired based on the actual data sets, and the reliability of subsequent pruning is improved, so that the precision of the neural network after pruning is improved, and the data processing efficiency and precision are improved.

In some embodiments, a target network layer pruned in the original neural network is determined according to the parameter redundancies of parameters of the candidate network layer at different pruning rates so as to generate a target neural network to process a target data set.

The target network layer refers to the target network layer that is determined to be pruned based on an adjusted pruning rate, after the pruning rate of the candidate network layer is re-adjusted according to the parameter redundancies, and the target neural network refers to the neural network after the target network layer is pruned from the original neural network.

In the embodiment of the present disclosure, there are many ways to determine the pruned target network layer in the original neural network according to the parameter redundancies of the parameters of the candidate network layer at different pruning rates, which can be selected according to an application scenario, etc. and is not limited by the present embodiment. Examples are as follows.

In an optional implementation, it is possible to draw a performance index curve of the candidate network layer corresponding to the plurality of pruning rates according to performance losses of the plurality of test performance indexes relative to the reference performance index; calculate a slope of each of the plurality of pruning rates in the performance index curve, and determine a maximum pruning rate of the candidate network layer according to a change of the slope, wherein a performance index corresponding to the maximum pruning rate represents a maximum parameter redundancy of the parameters of the candidate network layer; determine the target network layer pruned in the original neural network according to the target pruning rate, and the maximum pruning rate corresponding to the maximum parameter redundancy of each of the candidate network layers.

In another optional implementation, the maximum pruning rate of each of the candidate network layers is determined according to the parameter redundancies, and the target network layer pruned in the original neural network is determined directly according to the maximum pruning rate.

Based on the description of the above embodiment, different application scenarios have different compression requirements for the network, so the pruning rates are different. Pruning attempts with different pruning rates need to be performed for the candidate network layer, and the accuracy rates of the test data set after pruning are taken as the parameter redundancies of the candidate network layer at different pruning rates. Therefore, different norm criteria are needed to evaluate and select different pruners for pruning processing, and the number of channels among different candidate network layers in the original neural network may have dependency relation, and different candidate network layers with channel dependency relation need to be associated for pruning so as to further improve the processing efficiency.

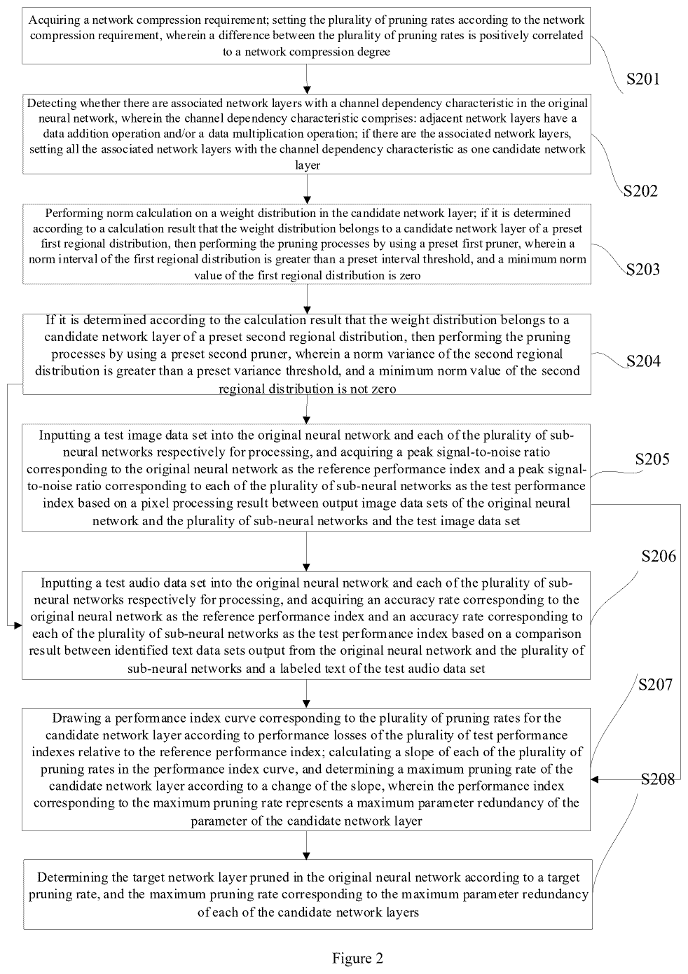

In the embodiment of the present disclosure, the parameter redundancies of the candidate network layer are analyzed from the performance losses between the test performance indexes obtained by the sub-neural networks obtained at different pruning rates processing the test data set and the reference performance index obtained by the original neural network processing the test data set, so as to obtain a relative parameter redundancy of the specified candidate network layer in the original neural network at the specified pruning rate, and the parameter redundancy is calculated based on the actual test data set and has high reliability. In addition, in the process of solving the parameter redundancy, in order to further improve the reliability, different pruners are selected for different weight distribution layers; and meanwhile, for the candidate network layers with channel dependency relation, whether these candidate network layers should be pruned is comprehensively considered and calculated for each pruning rate, then the parameter redundancy of each of the candidate network layer is calculated respectively, and finally, an average of the parameter redundancies of these layers is taken as the parameter redundancy of all layers to realize calculation of the parameter redundancy with channel dependency perceived, which is described in detail in conjunction with FIG. 2 below.

Specifically, FIG. 2 is a schematic flow diagram of another data processing method provided by an embodiment of the present disclosure. On the basis of the above embodiment, the present embodiment further optimizes the above data processing method. As shown in FIG. 2, the method includes:

Step 201, acquiring network compression requirements, setting the plurality of pruning rates according to the network compression requirements, wherein a difference between the plurality of pruning rates is positively correlated to a network compression degree.

Specifically, in the process of analyzing the parameter redundancies, pruning attempts with different pruning rates need to be performed for the candidate network layer, and the accuracy rate of the test data set after pruning is taken as the parameter redundancy of the candidate network layer at a different pruning rate.

In the embodiment of the present disclosure, different application scenarios have different requirements for network compression. For example, audio processing platforms have a high requirement for network compression, so more pruning rates need to be set for pruning attempts, so that a more precise parameter redundancy is needed, thereby further improving the processing precision of final acquisition of the target neural network. For another example, image processing platforms have a low requirement for network compression, so relatively less pruning rates need to be set for pruning attempts so as to improve the efficiency of adjusting the original neural network.

Data difference between the plurality of pruning rates is positively correlated to the network compression degree. That is to say, the greater the difference between the plurality of pruning rates, the greater the network compression degree; the smaller the difference between the plurality of pruning rates, the smaller the network compression degree.

Step 202, detecting whether there are associated network layers with channel dependency characteristic in the original neural network, wherein the channel dependency characteristic include: adjacent network layers have at least one of a data addition operation and a data multiplication operation; if there are associated network layers, setting all the associated network layers with the channel dependency characteristic as one candidate network layer.

Specifically, because the number of channels between the candidate network layers in the original neural network may have a dependency relation, the pruning of associated network layers with channel dependency characteristic needs to be aligned to achieve the actual acceleration effect. Therefore, when the pruning sensitivity of associated network layers is analyzed, all the associated network layers should be set as one candidate network layer, so the associated network layers with channel dependency characteristic have the same parameter redundancy.

In the embodiment of the present disclosure, convolutional kernels with the pruning rate of p% in the n-th candidate network layer are selected according to a certain convolutional kernel evaluation criterion, that is, N*p% convolutional kernels are pruned, and all other layers of the original neural network remain unchanged. The performance of the original neural network on the test data set is directly tested as B, and the pruning performance loss of the n-th candidate network layer at the pruning rate of p% is defined as S. A larger S means a greater precision loss caused by pruning the candidate network layer and a greater pruning sensitivity of the candidate network layer. A greater pruning sensitivity means that the candidate network layer contains more important convolutional kernels/feature map, so the candidate network layer can be considered to have a smaller parameter redundancy. Therefore, the parameter redundancy has a negative correlation relationship with the pruning sensitivity.

In the embodiment of the present disclosure, a plurality of performance indexes are the parameter redundancies of the candidate network layer corresponding to a plurality of pruning rates respectively, including: acquiring the number of all associated network layers with channel dependency characteristic among the candidate network layers, averaging the plurality of performance indexes for the number of layer, and acquiring the parameter redundancies of each associated network layer corresponding to the plurality of pruning rates respectively.

For example, suppose that there are two layers Conv1 and Conv2 with channel dependency characteristic, the parameter redundancies of Conv1 and Conv2 are analyzed in case where the pruning rate is p%. Firstly, Conv1 and Conv2 are considered comprehensively to select N*p% convolutional kernels to be pruned, then a first parameter redundancy and a second parameter redundancy are calculated according to pruning these convolutional kernels in Conv1, and finally an average of the first parameter redundancy and the second parameter redundancy is calculated as the parameter redundancy of Conv1 and Conv2 when the compression ratio is p%.

Step 203, performing norm calculation on a weight distribution in the candidate network layer; if it is determined according to a calculation result that the weight distribution belongs to a candidate network layer of a preset first regional distribution, then performing the pruning processes by using a preset first pruner, wherein a norm interval of the first regional distribution is greater than a preset interval threshold, and a minimum norm value of the first regional distribution is zero;

Step 204, if it is determined according to the calculation result that the weight distribution belongs to a candidate network layer of a preset second regional distribution, then performing the pruning processes by using a preset second pruner, wherein a norm variance of the second regional distribution is greater than a preset variance threshold, and a minimum norm value of the second regional distribution is not zero.

Specifically, in the process of analyzing the parameter redundancy, pruning attempts with different pruning rates need to be performed for the candidate network layer, and the accuracy rate of the test data set after pruning is taken as the parameter redundancies of the candidate network layer at different pruning rates. Therefore, the pruning performance directly affects the confidence of different pruning rates.

Specifically, the pruning strategy usually uses L1 norm/L2 norm to evaluate the importance of a convolutional kernel, and the norm-based evaluation criterion usually relies on two assumptions that are not always true: (1) the filters have a wide norm distribution and a large variance; (2) the minimum norm of the filters should be very small, approaching 0. Specifically, when the norm deviation of the filters is small, that is, the filters have a very dense norm distribution, it will be difficult to find a suitable threshold to achieve the desired target sparsity rate. Meanwhile, when the minimum norm of the filters is large, indicating that all the filters of the candidate network layer are very important, where a norm-based selection will then result in a loss of accuracy.

Therefore, in the above two cases, the norm-based evaluation criterion is no longer applicable. In the embodiment of the present disclosure, the weight distribution of the candidate network layer will be analyzed first before pruning. For the candidate network layer with the weight distribution conforming to a first regional distribution, a preset first pruner is used for pruning processing, that is, the one-shot pruning algorithm with a first norm is adopted, wherein the norm of the first regional distribution is greater than a preset range and the minimum value is zero, wherein the preset range is set according to needs of the application scenario. For the candidate network layer with the weight distribution conforming to a second regional distribution, a preset second pruner is used for pruning processing, that is, a one-shot pruning algorithm is adopted, in which filter pruning via geometric median is used, and the norm variance of the second region is greater than the preset threshold and the minimum value is not zero, wherein the preset threshold is set according to needs of the application scenario.

Step 205, inputting a test image data set into the original neural network and each of the plurality of sub-neural networks respectively for processing, and acquiring a peak signal-to-noise ratio corresponding to the original neural network as the reference performance index and a peak signal-to-noise ratio corresponding to each of the plurality of sub-neural networks as the test performance index based on a pixel processing result between output image data sets of the original neural network and the plurality of sub-neural networks and the test image data set.

In the embodiment of the present disclosure, for a picture-enhanced scenario, enhancement process needs to be performed on images. The test data set is a test image data set. The test image data set is input into the original neural network and each of the plurality of sub-neural networks respectively for processing to acquire output image data sets, and the peak signal-to-noise ratio corresponding to the original neural network is acquired as a reference performance index and the peak signal-to-noise ratio corresponding to each of the plurality of sub-neural networks is acquired as a test performance index through a pixel processing result between the output image data sets and the test image data set.

Thus, in the picture-enhanced scenario, the reference performance index corresponding to the original neural network and the test performance indexes corresponding to the sub-neural networks are acquired, so as to determine parameter redundancies of parameters of the candidate network layer in the original neural network at different pruning rates based on performance losses of the test performance indexes relative to the reference performance index, so that the image enhancement process performed by the network pruned based on the parameter redundancy has better processing efficiency and effect.

Step 206, inputting a test audio data set into the original neural network and each of the plurality of sub-neural networks respectively for processing, and acquiring an accuracy rate corresponding to the original neural network as the reference performance index and an accuracy rate corresponding to each of the plurality of sub-neural networks as the test performance index based on a comparison result between identified text data sets output from the original neural network and the plurality of sub-neural networks and labeled text of the test audio data set.

In the embodiment of the present disclosure, for a speech recognition scenario, recognition process needs to be performed on speech, and the test data set is a test audio data set. A test audio data set is input into the original neural network and each of the plurality of sub-neural networks respectively for processing to acquire identified text data sets, and an accuracy rate corresponding to the original neural network is acquired as the reference performance index and an accuracy rate corresponding to each of the plurality of sub-neural networks is acquired as the test performance index based on a comparison result between identified text data sets and labeled text of the test audio data set.

Thus, in the speech recognition scenario, the reference performance index corresponding to the original neural network and the test performance indexes corresponding to the sub-neural networks are acquired, so as to determine parameter redundancies of parameters of the candidate network layer in the original neural network at different pruning rates based on performance losses of the test performance indexes relative to the reference performance index, so that the speech recognition process performed by the network pruned based on the parameter redundancies has better processing efficiency and effect.

Step 207, drawing a performance index curve corresponding to the plurality of pruning rates for the candidate network layer according to performance losses of the plurality of test performance indexes relative to the reference performance index; calculating a slope of each of the plurality of pruning rates in the performance index curve, and determining a maximum pruning rate of the candidate network layer according to a change of the slope, wherein the performance index corresponding to the maximum pruning rate represents a maximum parameter redundancy of the parameters of the candidate network layer.

Step 208, determining the target network layer pruned in the original neural network according to a target pruning rate, and the maximum pruning rate corresponding to the maximum parameter redundancy of each of the said candidate network layer.

In the embodiment of the present disclosure, the performance index curve of the candidate network layer corresponding to the plurality of pruning rates is drawn according to the parameter redundancies. That is to say, the plurality of pruning rates are taken as a horizontal axis and the parameter redundancies, namely performance losses of the plurality of test performance indexes relative to the reference performance index, are taken as a vertical coordinate to draw the performance index curve, so as to obtain a slope of each of the pruning rates. The maximum pruning rate of the candidate network layer is determined according to a change of the slope, for example, the pruning rate with the maximum slope change is the maximum pruning rate of the candidate network layer, and the performance index corresponding to the maximum pruning rate represents the maximum parameter redundancy corresponding to the parameters of the candidate network layer.

Further, the target network layer pruned in the original neural network is determined according to a target pruning rate and the maximum pruning rate corresponding to the maximum parameter redundancy of each of the candidate network layers, so as to generate a target neural network to process a target data set. That is to say, after determining the maximum pruning rate, it is also possible to determine the target pruning rate based on a specific scenario, and determine the target network layer pruned in the original neural network based on the maximum parameter redundancy of each of the candidate network layers, so as to generate a target neural network to process the target data set. Thus, the acquired target neural network is more conformable to individualized requirements, and the data processing efficiency and precision are further improved.

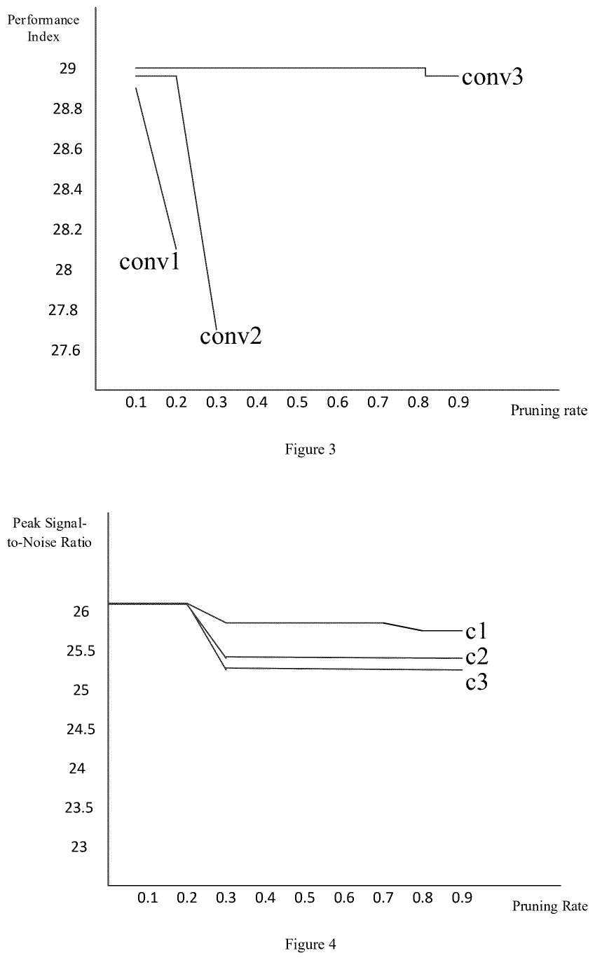

As a scenario example, a related tool can be used to analyze the performance loss for a designated candidate network layer of the original neural network at a preset pruning rate. The analysis principle is to perform structural pruning on the set candidate network layer at a preset pruning rate respectively, and then use the pruned sub-neural network to process the test data set for performance verification as the performance loss of the candidate network layer at the current pruning rate. An analysis result is shown in FIG. 3. There are great differences in pruning performance loss between candidate network layers. For some key candidate network layers, for example, conv1 and conv2 have larger performance losses when the pruning rate is 0.2 and 0.3respectively, that is to say, conv1 has a larger performance loss, and thus a smaller parameter redundancy, for the pruning rate of 0.2. Similarly, conv1 has a larger performance loss, and thus a smaller parameter redundancy, for the pruning rate of 0.3.

For another example, a few layers are extremely insensitive to pruning processing, so we can consider removing them from design of the original neural network, or increasing their pruning rates. For example, the performance index corresponding to conv3 is almost unchanged when the pruning rate is 0.1-0.9, that is, conv3 has a smaller performance loss for the pruning rate of 0.1-0.9, that is, conv3 has a larger parameter redundancy for the pruning rate of 0.1-0.9.

As another scenario example, an attention module is used to model a spatial dependency relationship so as to cause the original neural network to pay attention to more important spatial features and show excellent performance. As shown in FIG. 4, the parameter redundancy of the attention module is analyzed, and it can be seen that all the parameter redundancies of parameters of the three convolutional layers c1-c3 are highly ranked at each of the pruning rates, so it is proved that they have higher parameter redundancies. The three convolutional layers c1-c3 are simply reduced to one convolutional layer, and finally it is shown that the performance has no loss after the original neural network is re-trained.

The data processing solution provided by the embodiment of the present disclosure comprises: acquiring network compression requirements; setting a plurality of pruning rates according to the network compression requirements, wherein differences between the plurality of pruning rates are positively correlated to a network compression degree; detecting whether there are associated network layers with channel dependency characteristic in the original neural network, wherein the channel dependency characteristic comprises: adjacent network layers have at least one of a data addition operation and a data multiplication operation; if there are the associated network layers, setting all the associated network layers with the channel dependency characteristic as one candidate network layer; performing norm calculation on a weight distribution in the candidate network layer; if it is determined according to a calculation result that the weight distribution belongs to a candidate network layer of a preset first regional distribution, then performing the pruning processes by using a preset first pruner, wherein a norm interval of the first regional distribution is greater than a preset interval threshold, and a minimum norm value of the first regional distribution is zero; if it is determined according to the calculation result that the weight distribution belongs to a candidate network layer of a preset second regional distribution, then performing the pruning processes by using a preset second pruner, wherein a norm variance of the second regional distribution is greater than a preset variance threshold, and a minimum norm value of the second regional distribution is not zero; inputting a test image data set into the original neural network and each of the plurality of sub-neural networks respectively for processing, and acquiring a peak signal-to-noise ratio corresponding to the original neural network as the reference performance index and a peak signal-to-noise ratio corresponding to each of the plurality of sub-neural networks as the test performance index based on a pixel processing result between output image data sets of the original neural network and the plurality of sub-neural networks and the test image data set; or inputting a test audio data set into the original neural network and each of the plurality of sub-neural networks respectively for processing, and acquiring an accuracy rate corresponding to the original neural network as the reference performance index and an accuracy rate corresponding to each of the plurality of sub-neural networks as the test performance index based on a comparison result between identified text data sets output from the original neural network and the plurality of sub-neural networks and a labeled text of the test audio data set; drawing a performance index curve corresponding to the plurality of pruning rates for the candidate network layer according to a performance loss of the plurality of test performance indexes relative to the reference performance index; calculating a slope of each of the plurality of pruning rates in the performance index curve, and determining a maximum pruning rate of the candidate network layer according to a change of the slope, wherein a performance index corresponding to the maximum pruning rate represents a maximum parameter redundancy of the parameter of the candidate network layer; determining the target network layer pruned in the original neural network according to a target pruning rate, and the maximum pruning rate corresponding to the maximum parameter redundancy of each of the candidate network layers. By adopting the technical solution, the relative parameter redundancies of each of the candidate network layer in the original neural network at the specified pruning rates are analyzed, and the parameter redundancies are acquired based on the actual test data set and have high reliability. In addition, in the process of solving the parameter redundancies, in order to further improve the reliability, different pruners are selected for the pruning process for the weight distribution in the candidate network layer. Meanwhile, all associated network layers with channel dependency characteristic are set as one candidate network layer, and the parameter redundancies of each of the associated network layers corresponding to the plurality of pruning rates are acquired according to the average calculation of the number of all associated network layers, which further improves the precision of subsequent calculation, thus improving the reliability of the target neural network.

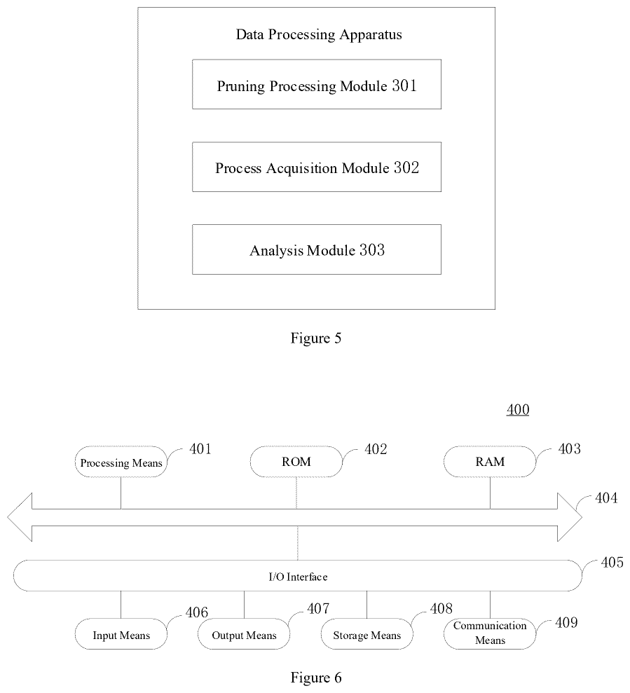

FIG. 5 is a schematic structural diagram of a data processing apparatus provided by an embodiment of the present disclosure, The apparatus can be implemented by software and/or hardware and can be generally integrated in an electronic device. As shown in FIG. 5, the apparatus includes:
a pruning processing module 301 for performing a pruning process on each of the candidate network layers in an original neural network according to a preset plurality of pruning rates respectively, so as to acquire a corresponding plurality of sub-neural networks;
an acquisition processing module 302 for inputting a test data set into the original neural network and the plurality of sub-neural networks respectively for processing, and acquiring a reference performance index corresponding to the original neural network and a plurality of test performance indexes corresponding to the plurality of sub-neural networks based on output data sets of the original neural network and the plurality of sub-neural networks;
an analysis module 303 for analyzing parameter redundancies of parameters of the candidate network layer in the original neural network at different pruning rates according to performance losses of the plurality of test performance indexes relative to the reference performance index.

Optionally, the test data set includes: multimedia data, wherein the multimedia data is one or more combinations of audio data, video data, and image data.

Optionally, the apparatus further includes:
an acquisition module for acquiring network compression requirements;
a setting module for setting the plurality of pruning rates according to the network compression requirements, wherein a difference between the plurality of pruning rates is positively correlated to a network compression degree.

Optionally, the pruning processing module 301 is specifically used for:
performing norm calculation on a weight distribution in the candidate network layer;
if it is determined according to a calculation result that the weight distribution belongs to a candidate network layer of a preset first regional distribution, then performing the pruning processes by using a preset first pruner, wherein a norm interval of the first regional distribution is greater than a preset interval threshold, and a minimum norm value of the first regional distribution is zero;
if it is determined according to the calculation result that the weight distribution belongs to a candidate network layer of a preset second regional distribution, then performing the pruning processes by using a preset second pruner, wherein a norm variance of the second regional distribution is greater than a preset variance threshold, and a minimum norm value of the second regional distribution is not zero.

Optionally, the processing acquisition module 302 is specifically used for:
inputting a test image data set into the original neural network and each of the plurality of sub-neural networks respectively for processing, and acquiring a peak signal-to-noise ratio corresponding to the original neural network as the reference performance index and a peak signal-to-noise ratio corresponding to each of the plurality of sub-neural networks as the test performance index based on a pixel processing result between output image data sets of the original neural network and the plurality of sub-neural networks and the test image data set;
or,
inputting a test audio data set into the original neural network and each of the plurality of sub-neural networks respectively for processing, and acquiring an accuracy rate corresponding to the original neural network as the reference performance index and an accuracy rate corresponding to each of the plurality of sub-neural networks as the test performance index based on a comparison result between identified text data sets output from the original neural network and the plurality of sub-neural networks and a labeled text of the test audio data set.

Optionally, the apparatus further includes:
a detection module for detecting whether there are associated network layers with channel dependency characteristic in the original neural network, wherein the channel dependency characteristic comprises: adjacent network layers have at least one of a data addition operation and a data multiplication operation;
an association setting module for setting, if there are the associated network layers, all the associated network layers with the channel dependency characteristic as one candidate network layer.

Optionally, the apparatus further includes:
an acquisition calculation module for acquiring a number of all associated network layers with channel dependency characteristic among the candidate network layers, averaging the plurality of performance indexes for the number of layers, and acquiring the parameter redundancies of each of the associated network layers corresponding to the plurality of pruning rates respectively.

Optionally, the apparatus further includes a determination module for:
determining a target network layer pruned in the original neural network according to parameter redundancies of parameters of the candidate network layer at different pruning rates, so as to generate a target neural network to process a target data set.

Optionally, the determination module is specifically used for:
drawing a performance index curve corresponding to the plurality of pruning rates for the candidate network layer according to performance losses of the plurality of test performance indexes relative to the reference performance index;
calculating a slope of each of the plurality of pruning rates in the performance index curve, and determining a maximum pruning rate of the candidate network layer according to a change of the slope, wherein a performance index corresponding to the maximum pruning rate represents a maximum parameter redundancy of the parameters of the candidate network layer;
determining the target network layer pruned in the original neural network according to a target pruning rate, and the maximum pruning rate corresponding to the maximum parameter redundancy of each of the candidate network layers. The data processing apparatus provided by the embodiment of the present disclosure can execute the data processing method provided by any embodiment of the present disclosure, and has corresponding functional modules for executing the method and beneficial effects. Compared with related technologies, the technical solution provided by the embodiment of the present disclosure has the following advantages: the data processing solution provided by the embodiment of the present disclosure comprises: performing pruning processes on a candidate network layer in an original neural network according to a preset plurality of pruning rates respectively, so as to acquire a corresponding plurality of sub-neural networks; inputting a test data set into the original neural network and the plurality of sub-neural networks respectively for processing, and acquiring a reference performance index corresponding to the original neural network and a plurality of test performance indexes corresponding to the plurality of sub-neural networks based on output data sets of the original neural network and the plurality of sub-neural networks; analyzing parameter redundancies of parameters of the candidate network layer in the original neural network at different pruning rates according to performance losses of the plurality of test performance indexes relative to the reference performance index. By adopting the above technical solution, the parameter redundancies are acquired based on the actual test data set, and the reliability of subsequent pruning is improved, so that the precision of the neural network after pruning is improved, and the data processing efficiency and precision are improved.

An embodiment of the present disclosure also provides a computer program product, including computer programs/instructions which, when executed by a processor, implement the data processing method provided by any embodiment of the present disclosure.

FIG. 6 is a schematic structural diagram of an electronic device provided by an embodiment of the present disclosure. Referring specifically to FIG. 6 below, there is shown a schematic structural diagram of an electronic device 400 suitable for implementing an embodiment of the present disclosure. The electronic device 400 in the embodiment of the present disclosure can include, but is not limited to, a mobile terminal such as a mobile phone, a notebook computer, a digital broadcast receiver, a Personal Digital Assistant (PDA), a Tablet Computer (PAD), a Portable Multimedia Player (PMP), a vehicle-mounted terminal (e.g. a vehicle-mounted navigation terminal), and etc., as well as a fixed terminal such as a digital TV, a desktop computer, and etc. The electronic device shown in FIG. 6 is just an example, and should not bring any limitation to the functions and application scope of the embodiment of the present disclosure.

As shown in FIG. 6, the electronic device 400 can include a processing means (such as a central processor, a graphics processor, etc.) 401, which can execute various appropriate actions and processes according to a program stored in a Read-Only Memory (ROM) 402 or a program loaded from a storage means 408 into a Random Access Memory (RAM) 403. In the RAM 403, various programs and data required for the operation of the electronic device 400 are also stored. The processing means 401, the ROM 402 and the RAM 403 are connected to each other via a bus 404. An input/output (I/O) interface 405 is also connected to the bus 404.

Generally, the following means can be connected to the I/O interface 405: an input means 406 including, for example, a touch screen, a touch pad, a keyboard, a mouse, a camera, a microphone, an accelerometer, a gyroscope, etc.; an output means 407 including, for example, a liquid crystal display (LCD), a speaker, a vibrator, etc.; a storage means 408 including, for example, a magnetic tape, a hard disk, etc.; and a communication means 409. The communication means 409 can allow the electronic device 400 to perform wireless or wired communication with other devices to exchange data. Although FIG. 6 shows an electronic device 400 with various means, it should be understood that it is not required to implement or provide all the means shown. More or fewer means can alternatively be implemented or provided.

In particular, according to an embodiment of the present disclosure, the process described above with reference to the flow diagram can be implemented as a computer software program. For example, an embodiment of the present disclosure includes a computer program product including a computer program carried on a non-transitory computer readable medium, which contains program codes for executing the method shown in the flow diagram. In such an embodiment, the computer program can be downloaded and installed from the network through the communication means 409, or installed from the storage means 408, or installed from the ROM 402. When executed by the processing means 401, the computer program executes the above functions defined in the data processing method of the embodiment of the present disclosure.

It should be noted that the computer readable medium mentioned above in the present disclosure can be a computer readable signal medium or a computer readable storage medium or any combination of the two. The computer readable storage medium can be, for example, but not limited to, an electrical, magnetic, optical, electromagnetic, infrared, or semiconductor system, apparatus, device, or a combination of any of the above. More specific examples of the computer readable storage medium can include, but are not limited to, an electrical connection with one or more wires, a portable computer disk, a hard disk, a Random Access Memory (RAM), a Read-Only Memory (ROM), an Erasable Programmable Read-Only Memory (EPROM or flash memory), an optical fiber, a portable Compact Disk Read-Only Memory (CD-ROM), an optical storage device, a magnetic storage device, or any appropriate combination of the above. In the present disclosure, the computer readable storage medium can be any tangible medium containing or storing a program, which can be used by or in combination with an instruction execution system, apparatus or device. In the present disclosure, the computer readable signal medium can include a data signal propagated in baseband or as part of a carrier wave, in which computer readable program codes are carried. This propagated data signal can take many forms, including but not limited to an electromagnetic signal, an optical signal or any appropriate combination of the above. The computer readable signal medium can also be any computer readable medium other than the computer readable storage medium, which can send, propagate or transmit a program for use by or in connection with an instruction execution system, apparatus or device. The program codes contained in the computer readable medium can be transmitted by any appropriate medium, including but not limited to: wires, optical cables, radio frequency (RF) and the like, or any appropriate combination of the above.

In some implementations, clients and servers can communicate by using any currently known or future developed network protocol such as Hyper Text Transfer Protocol (HTTP), and can be interconnected with digital data communication in any form or medium (for example, a communication network). Examples of the communication network include a Local Area Network (“LAN”), a Wide Area Network (“WAN”), an interconnecting network (for example, the Internet) and end-to-end networks (for example, ad hoc end-to-end networks), as well as any currently known or future developed networks.

The above computer readable medium can be contained in the above electronic device, or it can exist alone without being assembled into the electronic device.

The above computer readable medium carries one or more programs which, when executed by the electronic device, cause the electronic device to: receive an information display trigger operation of a user during playback of a video; acquiring at least two pieces of target information associated with the video; displaying a first piece of target information of the at least two pieces of target information in an information display area of a playing page of the video, wherein the size of the information display area is smaller than that of the playing page; receiving a first switching trigger operation of a user, and switching the first piece of target information displayed in the information display area to a second piece of target information of the at least two pieces of target information.

Computer program codes for executing the operations of the present disclosure can be written in one or more programming languages or combinations thereof, including but not limited to an object-oriented programming language, such as Java, Smalltalk, C++, and a conventional procedural programming language, such as “C” language or similar programming languages. The program codes can be completely executed on the user computer, partially executed on the user computer, executed as an independent software package, partially executed on the user computer and partially executed on a remote computer, or completely executed on the remote computer or server. In the case involving a remote computer, the remote computer can be connected to a user computer through any kind of network, including a Local Area Network (LAN) or a Wide Area Network (WAN), or can be connected to an external computer (for example, through the Internet using an Internet service provider).

The flow diagrams and block diagrams in the drawings illustrate the architecture, functions and operations of possible implementations of the system, method and computer program product according to various embodiments of the present disclosure. In this regard, each block in the flow diagrams or block diagrams can represent a module, a program segment, or a part of code that contains one or more executable instructions for implementing specified logical functions. It should also be noted that in some alternative implementations, the functions noted in the blocks can occur in a different order than those noted in the drawings. For example, two blocks shown in succession can actually be executed substantially in parallel, and they can sometimes be executed in the reverse order, depending on the functions involved. It should also be noted that each block in the block diagrams and/or flow diagrams, and combinations of blocks in the block diagrams and/or flow diagrams, can be implemented by a dedicated hardware-based system that executes specified functions or operations, or by a combination of dedicated hardware and computer instructions.

The involved units described in the embodiments of the present disclosure can be implemented by software or hardware. A name of the unit does not constitute the limitation of the unit itself in some cases.

The functions described above herein can be at least partially executed by one or more hardware logical components. For example, without limitation, exemplary types of hardware logical components that can be used include: Field Programmable Gate Array (FPGA), Application Specific Integrated Circuit (ASIC), Application Specific Standard Product (ASSP), System on Chip (SOC), Complex Programmable Logic Device (CPLD) and so on.

In the context of the present disclosure, a machine readable medium can be a tangible medium that may contain or store a program for use by or in connection with an instruction execution system, apparatus or device. The machine readable medium can be a machine readable signal medium or a machine readable storage medium. The machine readable medium can include, but is not limited to, an electronic, magnetic, optical, electromagnetic, infrared, or semiconductor system, apparatus or device, or any appropriate combination of the above. More specific examples of the machine readable storage medium can include an electrical connection based on one or more lines, a portable computer disk, a hard disk, a Random Access Memory (RAM), a Read-Only Memory (ROM), an Erasable Programmable Read-Only Memory (EPROM or flash memory), an optical fiber, a Convenient Compact Disk Read-Only Memory (CD-ROM), an optical storage device, a magnetic storage device, or any appropriate combination of the above.

According to one or more embodiments of the present disclosure, the present disclosure provides an electronic device including:
a processor;
a memory for storing executable instructions;
wherein the executable instructions can be read from the memory and executed by the processor to implement any of the data processing methods as provided by the present disclosure.

According to one or more embodiments of the present disclosure, the present disclosure provides a computer readable storage medium storing a computer program for executing any of the data processing methods as provided by the present disclosure.

According to one or more embodiments of the present disclosure, the present disclosure provides a computer program comprising: instructions which, when executed by a processor, cause the processor to execute any of the data processing methods as provided by the present disclosure.

The above description is only the explanation of the preferred embodiments of the present disclosure and the applied technical principles. It should be understood by those skilled in the art that the disclosure scope involved in the present disclosure is not limited to the technical solution formed by the specific combination of the above technical features, but also covers other technical solution formed by any combination of the above technical features or their equivalent features without departing from the above disclosure concept. For example, a technical solution formed by a mutual replacement of the above features with technical features with similar functions disclosed in the present disclosure (but not limited to).

Furthermore, although the operations are depicted in a particular order, this should not be understood as requiring that these operations be executed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any appropriate sub-combination.

Although the subject matter has been described in a language specific to structural features and/or methodological logical acts, it should be understood that the subject matters defined in the appended Claims are not necessarily limited to the specific features or acts described above. On the contrary, the specific features and acts described above are only exemplary forms of implementing the Claims.

1. A data processing method, comprising:
performing pruning processes on a candidate network layer in an original neural network according to a preset plurality of pruning rates respectively, so as to acquire a corresponding plurality of sub-neural networks;
inputting a test data set into the original neural network and the plurality of sub-neural networks respectively for processing, and acquiring a reference performance index corresponding to the original neural network and a plurality of test performance indexes corresponding to the plurality of sub-neural networks based on output data sets of the original neural network and the plurality of sub-neural networks;
analyzing parameter redundancies of parameters of the candidate network layer in the original neural network at different pruning rates according to performance losses of the plurality of test performance indexes relative to the reference performance index.

2. The data processing method according to claim 1, further comprising:
acquiring a network compression requirement;
setting the plurality of pruning rates according to the network compression requirement, wherein a difference between the plurality of pruning rates is positively correlated to a network compression degree.

3. The data processing method according to claim 1, wherein, the performing pruning processes according to a preset plurality of pruning rates respectively so as to acquire a corresponding plurality of sub-neural networks, comprises:
performing norm calculation on a weight distribution in the candidate network layer;
if it is determined according to a calculation result that the weight distribution belongs to a candidate network layer of a preset first regional distribution, then performing the pruning processes by using a preset first pruner, wherein a norm interval of the first regional distribution is greater than a preset interval threshold, and a minimum norm value of the first regional distribution is zero;
if it is determined according to the calculation result that the weight distribution belongs to a candidate network layer of a preset second regional distribution, then performing the pruning processes by using a preset second pruner, wherein a norm variance of the second regional distribution is greater than a preset variance threshold, and a minimum norm value of the second regional distribution is not zero.

4. The data processing method according to claim 1, wherein the test data set includes multimedia data, wherein the multimedia data is one or more combinations of audio data, video data, and image data.

5. The data processing method according to claim 4, wherein, the inputting a test data set into the original neural network and the plurality of sub-neural networks respectively for processing, and acquiring a reference performance index corresponding to the original neural network and a plurality of test performance indexes corresponding to the plurality of sub-neural networks based on output data sets of the original neural network and the plurality of sub-neural networks, comprises:
inputting a test image data set into the original neural network and each of the plurality of sub-neural networks respectively for processing, and acquiring a peak signal-to-noise ratio corresponding to the original neural network as the reference performance index and a peak signal-to-noise ratio corresponding to each of the plurality of sub-neural networks as the test performance index based on a pixel processing result between output image data sets of the original neural network and the plurality of sub-neural networks and the test image data set;
or,
inputting a test audio data set into the original neural network and each of the plurality of sub-neural networks respectively for processing, and acquiring an accuracy rate corresponding to the original neural network as the reference performance index and an accuracy rate corresponding to each of the plurality of sub-neural networks as the test performance index based on a comparison result between identified text data sets output from the original neural network and the plurality of sub-neural networks and a labeled text of the test audio data set.

6. The data processing method according to claim 1, further comprising:
detecting whether there are associated network layers with channel dependency characteristic in the original neural network, wherein the channel dependency characteristic comprises: adjacent network layers have at least one of a data addition operation and a data multiplication operation;
if there are the associated network layers, then setting all the associated network layers with the channel dependency characteristic as one candidate network layer.

7. The data processing method according to claim 1, further comprising:
determining a target network layer pruned in the original neural network according to parameter redundancies of parameters of the candidate network layer at different pruning rates, so as to generate a target neural network to process a target data set.

8. The data processing method according to claim 7, wherein, the determining a target network layer pruned in the original neural network according to parameter redundancies of parameters of the candidate network layer at different pruning rates, comprises:
drawing a performance index curve corresponding to the plurality of pruning rates for the candidate network layer according to the performance losses of the plurality of test performance indexes relative to the reference performance index;
calculating a slope of each of the plurality of pruning rates in the performance index curve, and determining a maximum pruning rate of the candidate network layer according to a change of the slope, wherein the performance index corresponding to the maximum pruning rate represents a maximum parameter redundancy of the parameters of the candidate network layer;
determining the target network layer pruned in the original neural network according to a target pruning rate, and the maximum pruning rate corresponding to the maximum parameter redundancy of each of the candidate network layers.

9. (canceled)

10. An electronic device, comprising:
a processor;
a memory for storing executable instructions;
wherein the executable instructions can be read from the memory and executed by the processor to implement a data processing comprising:
performing pruning processes on a candidate network layer in an original neural network according to a preset plurality of pruning rates respectively, so as to acquire a corresponding plurality of sub-neural networks;
inputting a test data set into the original neural network and the plurality of sub-neural networks respectively for processing, and acquiring a reference performance index corresponding to the original neural network and a plurality of test performance indexes corresponding to the plurality of sub-neural networks based on output data sets of the original neural network and the plurality of sub-neural networks;
analyzing parameter redundancies of parameters of the candidate network layer in the original neural network at different pruning rates according to performance losses of the plurality of test performance indexes relative to the reference performance index.

11. A non-transitory computer readable storage medium storing a computer program, which is used for executing a data processing method, comprising:
performing pruning processes on a candidate network layer in an original neural network according to a preset plurality of pruning rates respectively, so as to acquire a corresponding plurality of sub-neural networks;
inputting a test data set into the original neural network and the plurality of sub-neural networks respectively for processing, and acquiring a reference performance index corresponding to the original neural network and a plurality of test performance indexes corresponding to the plurality of sub-neural networks based on output data sets of the original neural network and the plurality of sub-neural networks;
analyzing parameter redundancies of parameters of the candidate network layer in the original neural network at different pruning rates according to performance losses of the plurality of test performance indexes relative to the reference performance index.

12-13. (canceled)

14. The electronic device according to claim 10, further comprising:
acquiring a network compression requirement;
setting the plurality of pruning rates according to the network compression requirement, wherein a difference between the plurality of pruning rates is positively correlated to a network compression degree.

15. The electronic device according to claim 10, wherein, the performing pruning processes according to a preset plurality of pruning rates respectively so as to acquire a corresponding plurality of sub-neural networks, comprises:
performing norm calculation on a weight distribution in the candidate network layer;
if it is determined according to a calculation result that the weight distribution belongs to a candidate network layer of a preset first regional distribution, then performing the pruning processes by using a preset first pruner, wherein a norm interval of the first regional distribution is greater than a preset interval threshold, and a minimum norm value of the first regional distribution is zero;
if it is determined according to the calculation result that the weight distribution belongs to a candidate network layer of a preset second regional distribution, then performing the pruning processes by using a preset second pruner, wherein a norm variance of the second regional distribution is greater than a preset variance threshold, and a minimum norm value of the second regional distribution is not zero.

16. The electronic device according to claim 10, wherein the test data set includes multimedia data, wherein the multimedia data is one or more combinations of audio data, video data, and image data.

17. The electronic device according to claim 16, wherein, the inputting a test data set into the original neural network and the plurality of sub-neural networks respectively for processing, and acquiring a reference performance index corresponding to the original neural network and a plurality of test performance indexes corresponding to the plurality of sub-neural networks based on output data sets of the original neural network and the plurality of sub-neural networks, comprises:
inputting a test image data set into the original neural network and each of the plurality of sub-neural networks respectively for processing, and acquiring a peak signal-to-noise ratio corresponding to the original neural network as the reference performance index and a peak signal-to-noise ratio corresponding to each of the plurality of sub-neural networks as the test performance index based on a pixel processing result between output image data sets of the original neural network and the plurality of sub-neural networks and the test image data set;
or,
inputting a test audio data set into the original neural network and each of the plurality of sub-neural networks respectively for processing, and acquiring an accuracy rate corresponding to the original neural network as the reference performance index and an accuracy rate corresponding to each of the plurality of sub-neural networks as the test performance index based on a comparison result between identified text data sets output from the original neural network and the plurality of sub-neural networks and a labeled text of the test audio data set.

18. The electronic device according to claim 10, further comprising:
detecting whether there are associated network layers with channel dependency characteristic in the original neural network, wherein the channel dependency characteristic comprises: adjacent network layers have at least one of a data addition operation and a data multiplication operation;
if there are the associated network layers, then setting all the associated network layers with the channel dependency characteristic as one candidate network layer.

19. The non-transitory computer readable storage medium according to claim 11, further comprising:
acquiring a network compression requirement;
setting the plurality of pruning rates according to the network compression requirement, wherein a difference between the plurality of pruning rates is positively correlated to a network compression degree.

20. The non-transitory computer readable storage medium according to claim 11, wherein, the performing pruning processes according to a preset plurality of pruning rates respectively so as to acquire a corresponding plurality of sub-neural networks, comprises:
performing norm calculation on a weight distribution in the candidate network layer;
if it is determined according to a calculation result that the weight distribution belongs to a candidate network layer of a preset first regional distribution, then performing the pruning processes by using a preset first pruner, wherein a norm interval of the first regional distribution is greater than a preset interval threshold, and a minimum norm value of the first regional distribution is zero;
if it is determined according to the calculation result that the weight distribution belongs to a candidate network layer of a preset second regional distribution, then performing the pruning processes by using a preset second pruner, wherein a norm variance of the second regional distribution is greater than a preset variance threshold, and a minimum norm value of the second regional distribution is not zero.

21. The non-transitory computer readable storage medium according to claim 11, wherein the test data set includes multimedia data, wherein the multimedia data is one or more combinations of audio data, video data, and image data.

22. The non-transitory computer readable storage medium according to claim 21, wherein, the inputting a test data set into the original neural network and the plurality of sub-neural networks respectively for processing, and acquiring a reference performance index corresponding to the original neural network and a plurality of test performance indexes corresponding to the plurality of sub-neural networks based on output data sets of the original neural network and the plurality of sub-neural networks, comprises:
inputting a test image data set into the original neural network and each of the plurality of sub-neural networks respectively for processing, and acquiring a peak signal-to-noise ratio corresponding to the original neural network as the reference performance index and a peak signal-to-noise ratio corresponding to each of the plurality of sub-neural networks as the test performance index based on a pixel processing result between output image data sets of the original neural network and the plurality of sub-neural networks and the test image data set;
or,
inputting a test audio data set into the original neural network and each of the plurality of sub-neural networks respectively for processing, and acquiring an accuracy rate corresponding to the original neural network as the reference performance index and an accuracy rate corresponding to each of the plurality of sub-neural networks as the test performance index based on a comparison result between identified text data sets output from the original neural network and the plurality of sub-neural networks and a labeled text of the test audio data set.

23. The non-transitory computer readable storage medium according to claim 11, further comprising:
detecting whether there are associated network layers with channel dependency characteristic in the original neural network, wherein the channel dependency characteristic comprises: adjacent network layers have at least one of a data addition operation and a data multiplication operation;
if there are the associated network layers, then setting all the associated network layers with the channel dependency characteristic as one candidate network layer.
